(19) United States
(12) Patent Application Publication
(10) Pub. No.: US 2025/0246748 A1
(43) Pub. Date: Jul. 31, 2025

(54) ENERGY STORAGE DEVICE AND ENERGY STORAGE APPARATUS

(71) Applicant: GS Yuasa International Ltd., Kyoto-shi (JP)

(72) Inventors: Ryoichi OKUYAMA, Kyoto-shi (JP); Kazuya OKABE, Kyoto-shi (JP); Hironori AIDA, Kyoto-shi (JP)

(73) Assignee: GS Yuasa International Ltd., Kyoto-shi (JP)

(21) Appl. No.: 18/846,073

(22) PCT Filed: Mar. 7, 2023
(86) PCT No.: PCT/JP2023/008463

§ 371 Date: Apr. 16, 2025

(30) Foreign Application Priority Data
Mar. 17, 2022 (JP) 2022-042630
Mar. 17, 2022 (JP) 2022-042803

(51) Int. Cl. H01M 50/342; H01M 10/613; H01M 10/625; H01M 10/647; H01M 50/209; H01M 50/249; H01M 50/367; H01M 50/547

(52) U.S. Cl. CPC H01M 50/342; H01M 10/613; H01M 10/625; H01M 10/647; H01M 50/209; H01M 50/249; H01M 50/367; H01M 50/547

(57) ABSTRACT

An energy storage device includes a container that accommodates an electrode assembly, and the container includes, on a surface of the container as viewed from a thickness direction of the container, a first recessed portion in a portion of a corner portion of the surface or in a portion of a side portion of the surface. The first recessed portion penetrates in the thickness direction, and a gas release valve is disposed in the first recessed portion.

### TECHNICAL FIELD

The present invention relates to an energy storage device and an energy storage apparatus.

### BACKGROUND ART

Conventionally, in an energy storage apparatus, a plurality of energy storage devices (angular batteries) each having a gas release valve (release port) are arrayed along a predetermined direction. The energy storage device also includes a duct (gas discharge duct) dedicatedly used for guiding a gas discharged from the gas release valves of the respective energy storage devices (see, for example, Patent Document 1). Further, conventionally, an energy storage device includes a gas release valve that is formed by reducing a thickness of a portion (battery lid) of a container by press working (see, for example, Patent Document 2).

### PRIOR ART DOCUMENTS

### Patent Documents

Patent Document 1: JP-A-2009-170258

Patent Document 2: JP-A-2022-000866

### SUMMARY OF THE INVENTION

### Problems to be Solved by the Invention

In recent years, in order to enhance manufacturing efficiency of an energy storage apparatus, there has been a demand for easily forming a flow path through which a gas discharged from the gas release valve flows. In view of the above circumstances, it is an object of the present invention to provide an energy storage device and an energy storage apparatus where a flow path through which a gas discharged from a gas release valve flows can be easily formed.

### Means for Solving the Problems

To achieve the above-mentioned object, according to one aspect of the present invention, there is provided an energy storage device including a container that accommodates an electrode assembly, in which the container includes, on a surface of the container as viewed from a thickness direction of the container, a first recessed portion in a portion of a corner portion of the surface or in a portion of a side portion of the surface, the first recessed portion penetrates in the thickness direction, and a gas release valve is disposed in the first recessed portion.

According to an aspect of the present invention, there is provided an energy storage apparatus that includes a plurality of the above-mentioned energy storage devices, and an outer case that accommodates the plurality of energy storage devices, in which the plurality of energy storage devices are arrayed in the thickness direction, and the first recessed portions of the plurality of energy storage devices communicate with each other in the thickness direction.

### ADVANTAGES OF THE INVENTION

According to the present invention, it is possible to provide an energy storage device and an energy storage apparatus capable of easily forming a gas flow path.

### BRIEF DESCRIPTION OF THE DRAWINGS

FIG. 1 is a perspective view illustrating an external appearance of an energy storage apparatus according to an embodiment.

FIG. 2 is an exploded perspective view of the energy storage apparatus according to the embodiment illustrating respective constitutional elements in a state where the energy storage apparatus is disassembled.

FIG. 3 is a perspective view illustrating an external appearance of an energy storage device according to the embodiment.

FIG. 4 is an exploded perspective view of the energy storage device according to the embodiment illustrating the respective constitutional elements in a state where the energy storage device is disassembled.

FIG. 5 is a perspective view illustrating the configuration of an electrode assembly according to the embodiment.

FIG. 6 is a plan view illustrating a first side surface portion according to the embodiment.

FIG. 7 is a plan view illustrating a first side surface portion according to a modification 1 of the embodiment.

FIG. 8 is a plan view illustrating a first side surface portion according to a modification 2 of the embodiment.

FIG. 9 is a plan view illustrating a first side surface portion according to a modification 3 of the embodiment.

FIG. 10 is a plan view illustrating a first side surface portion according to a modification 4 of the embodiment.

FIG. 11 is a cross-sectional view illustrating a portion of a lid body and a gas release valve according to a modification 5 of the embodiment.

FIG. 12 is a cross-sectional view illustrating a portion of a lid body and a gas release valve according to a modification 6 of the embodiment.

FIG. 13 is a cross-sectional view illustrating a portion of a lid body and a gas release valve according to a modification 7 of the embodiment.

FIG. 14 is a plan view illustrating a gas release valve according to a modification 8 of the embodiment.

### MODE FOR CARRYING OUT THE INVENTION

(1) An energy storage device according to one aspect of the present invention includes a container that accommodates an electrode assembly, in which the container includes, on a surface of the container as viewed from a thickness direction of the container, a first recessed portion in a portion of a corner portion of the surface or in a portion of a side portion of the surface, the first recessed portion penetrates in the thickness direction, and a gas release valve is disposed in the first recessed portion. In such a configuration, the thickness direction of the container is a direction along which the largest surfaces of the container face each other.

With such a configuration, the first recessed portion which is recessed on the wall surface of the container penetrates in the thickness direction, and the gas release valve is formed in the first recessed portion and hence, the first recessed portion can be used as a gas flow path. With such a configuration, for example, a gas flow path can be easily formed by the recessed portions by simply accommodating the energy storage device in the outer case of the energy storage apparatus. As described above, it is possible to provide the energy storage device capable of easily forming the gas flow path.

(2) In the energy storage device described in the above-mentioned (1), in which the container may be made of metal, the gas release valve may be made of metal and may be a member separate from the container, a hole may be formed in the first recessed portion, and the gas release valve may be configured to close the hole and may be joined to the container. With such a configuration, the gas release valve that is provided as a member separate from the container is joined to the container by covering the hole formed in the first recessed portion. Accordingly, the gas release valve can be easily disposed even in the first recessed portion that is difficult to be formed by press working.

(3) In the energy storage device described in the above-mentioned (2), in which the gas release valve may include an outer edge portion, the outer edge portion may be disposed outside a peripheral edge of the hole as viewed from a penetrating direction of the hole, a recessed portion that allows insertion of the outer edge portion therein may be formed in the container, and the outer edge portion may be welded to the container. With such a configuration, the recessed portion into which the outer edge portion of the gas release valve is inserted is formed in the container and hence, positioning between the gas release valve and the container can be performed easily at the time of assembling.

(4) In the energy storage device described in the above-mentioned (1) to (3), the energy storage device may further include a terminal, in which the container may include a second recessed portion in a corner portion of the surface in the surface, and the terminal may be disposed in the second recessed portion. With such a configuration, as compared with the configuration where the terminal is disposed on the upper surface of the container of the energy storage device, a height (a length in the Z-axis direction) of the energy storage device can be lowered. As a result, the energy density of the energy storage device can be increased. In addition, by accommodating the terminal in the second recessed portion, it is possible to protect the periphery of the terminal when the energy storage device receives an impact caused by collision, falling, or the like. As a result, the possibility of the occurrence of short-circuiting can be reduced.

(5) In the energy storage device described in the above-mentioned (4), in which the corner portion where the first recessed portion is formed and the corner portion where the second recessed portion is formed may be disposed adjacently to each other on the surface. With such a configuration, a gas diffusion path when a gas is discharged and an electricity supply path that includes the terminal can be separated from each other. As a result, a possibility of occurrence of short-circuiting caused by a discharged metal piece or the like can be reduced.

(6) An energy storage apparatus according to an aspect of the present invention includes a plurality of energy storage devices described in any one of the above-mentioned (1) to (5), and an outer case that accommodates the plurality of energy storage devices, in which the plurality of energy storage devices are arrayed in the thickness direction, and the first recessed portions of the plurality of energy storage devices communicate with each other in the thickness direction. With such a configuration, the plurality of energy storage devices each having the first recessed portion in the container are accommodated in the outer case in a posture where the first recessed portions are arrayed in a row and hence, it is possible to form a gas flow path formed of the respective first recessed portions in the outer case. Also in this case, by simply accommodating the respective energy storage devices in the outer case, the gas flow path can be easily formed by the first recessed portions and the outer case.

(7) In the energy storage apparatus described in the above-mentioned (6), in which a cooling unit may be disposed at a position of the outer case, the position facing the first recessed portion. With such a configuration, the cooling unit is disposed at a position corresponding to the first recessed portion and hence, the gas which flows through the first recessed portion can be cooled by the cooling unit. As a result, it is possible to suppress the normal energy storage device from becoming a high temperature caused by a gas that flows in the flow path (first recessed portion).

(8) The energy storage apparatus described in the above-mentioned (6) or (7) may further include a gas discharge member disposed in the first recessed portion, in which the gas discharge member may be disposed over the plurality of energy storage devices in an array direction of the plurality of energy storage devices. With such a configuration, the gas discharge member extends between the first recessed portions of the plurality of energy storage devices and hence, it is possible to cover a gap between the energy storage devices disposed adjacently to each other with the gas discharge member. With such a configuration, leaking of a gas that flows through the flow path (first recessed portion) from the gap can be suppressed by the gas discharge member.

(9) An energy storage apparatus according to another aspect of the present invention includes a plurality of energy storage devices described in a plurality of the above-mentioned (4) or (5), and an outer case that accommodates the plurality of energy storage devices, in which the plurality of energy storage devices are arrayed in the thickness direction, and second the recessed portions of the plurality of energy storage devices communicate with each other in the thickness direction. With such a configuration, as compared with the configuration where the terminal is disposed on the upper surface of the container of the energy storage device, a height (a length in the Z-axis direction) of the energy storage device can be lowered. As a result, the energy density of the energy storage apparatus can be increased. In addition, it is possible to reduce a possibility of occurrence of a short circuit during an operation of manufacturing or maintenance of the energy storage apparatus.

### Embodiment

Hereinafter, an energy storage apparatus and energy storage devices according to an embodiment (including modifications of the embodiment) of the present invention are described with reference to the drawings. All of the embodiment and modifications described hereinafter exemplify a comprehensive examples or specific examples. Numerical values, shapes, materials, constitutional elements, array positions and connection modes of the constitutional elements, manufacturing steps, the order of the manufacturing steps, and the like described in the following embodiment are provided as examples, and are not intended to limit the present invention. In the respective drawings, sizes and the like are not strictly illustrated. In the respective drawings, identical or substantially identical constitutional elements are given the same symbols.

In the following description and drawings, a longitudinal direction of the energy storage device and a direction along a winding axis of an electrode assembly disposed in the energy storage device are defined as an X-axis direction. An array direction of the plurality of energy storage devices and a thickness direction of a container of the energy storage device are defined as a Y-axis direction. A direction along which a case lid body and a case body of the energy storage apparatus are arrayed, a direction along which a bottom surface of a container body of the container and a top surface of a lid body are arrayed, and a vertical direction is defined as a Z-axis direction. These X-axis direction, Y-axis direction, and Z-axis direction are the directions that intersect with each other (the directions being orthogonal to each other in this embodiment). A case is also considered where the Z-axis direction is not the vertical direction depending on a use mode. However, in the description made hereinafter, for the sake of convenience of the description, the description is made by assuming the Z-axis direction as the vertical direction. In the description made hereinafter, the expression “insulation” means “electrical insulation”.

In the description made hereinafter, for example, an X-axis plus direction indicates an arrow direction of the X-axis, and an X-axis minus direction indicates a direction opposite to the X-axis plus direction. The same goes for the Y-axis direction and the Z-axis direction. Expressions indicating the relative directions or the relative postures such as “parallel” or “orthogonal” also include cases where such directions or postures are not taken in a strict meaning of the terms. For example, a state where two directions are orthogonal to each other means not only a state where these two directions are completely orthogonal to each other but also a state where these two directions are substantially orthogonal to each other, that is, for example, a state where these two directions are orthogonal to each other with slight deviation of approximately several percent.

### [Description of Energy Storage Apparatus]

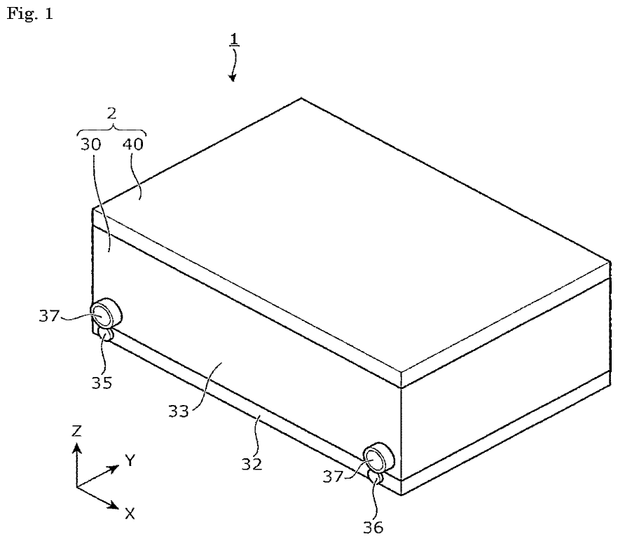

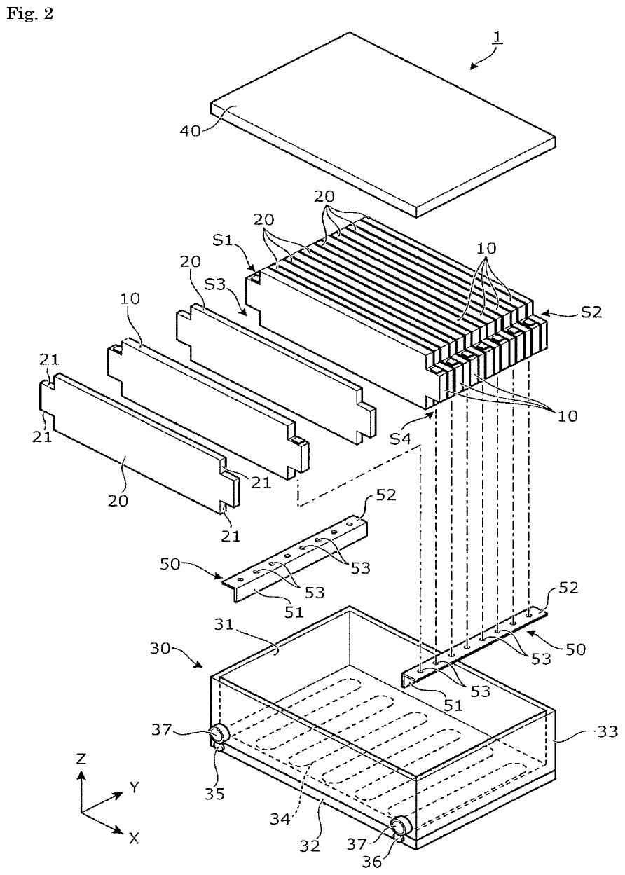

First, the overall configuration of the energy storage apparatus 1 according to this embodiment is described. FIG. 1 is a perspective view illustrating an external appearance of the energy storage apparatus 1 according to the embodiment. FIG. 2 is an exploded perspective view of the energy storage apparatus 1 according to the embodiment illustrating respective constitutional elements in a state where the energy storage apparatus 1 is disassembled.

The energy storage apparatus 1 is an apparatus into which electricity can be charged from the outside and from which electricity can be discharged to the outside. In this embodiment, the energy storage apparatus 1 has an approximately rectangular parallelepiped shape. The energy storage apparatus 1 is a battery module (assembled battery) used in an electricity storage application, a power source application, or the like. The energy storage apparatus 1 is used as a battery or the like for driving a moving body such as an automobile, a motorcycle or a railway vehicle, or a battery or the like for starting an engine. As the above-described automobile, an electric vehicle (EV), a hybrid electric vehicle (HEV), a plug-in hybrid electric vehicle (PHEV), and an automobile that uses a fossils fuel (a gasoline, a light oil, a liquefied natural gas or the like) are exemplified.

As illustrated in FIG. 1, the energy storage apparatus 1 includes a case 2. As shown in FIG. 2, a plurality of energy storage devices 10, a plurality of spacers 20, a pair of gas discharge members 50, a plurality of bus bars (not shown) and the like are accommodated in the case 2. The energy storage apparatus 1 also includes external terminals (a positive electrode external terminal and a negative electrode external terminal) for electrical connection with an external device, and the like. However, the illustration and the description of these constitutional elements are omitted. In addition to the above-mentioned constitutional elements, the energy storage apparatus 1 may include: binding members (end plates, side plates and the like) that bind the plurality of energy storage devices 10; a bus bar holder that holds the bus bars; a bus bar cover; a circuit board that monitors or controls a state of charge, a state of discharge and the like of each of the energy storage devices 10; and electric parts such as relays, fuses, shunt resistors and connectors.

The case 2 constitutes an outer case (housing, outer shell) of the energy storage apparatus 1. The case 2 is disposed outside the plurality of energy storage devices 10, the plurality of spacers 20 and the like, and fixes the plurality of energy storage devices 10, the plurality of spacers 20 and the like at predetermined positions so as to protect these energy storage devices 10, spacers 20 and the like from an impact or the like. The case 2 is a metal case formed of a member made of metal such as aluminum, an aluminum alloy, stainless steel, iron, or a plated steel plate. The case 2 may be formed of a member having insulating property such as a resin material. When the case 2 is formed using a conductive material, an inner surface of the case 2 may be covered with an insulating material by coating in order to ensure insulation against the energy storage devices.

As illustrated in FIG. 2, the case 2 includes: a case body 30 that constitutes a body of the case 2; and a case lid body 40 that constitutes a lid body of the case 2. The case body 30 is a bottomed rectangular cylindrical housing (casing) having an opening 31 formed in the Z axis plus direction. The case body 30 houses the plurality of energy storage devices 10, the plurality of spacers 20 and the like.

Specifically, the case body 30 has a bottom wall 32 and a side wall 33. The bottom wall 32 is a flat plate-shaped rectangular portion that is disposed on an end portion of the case body 30 in the Z axis minus direction. Inside the bottom wall 32, a refrigerant pipe 34 through which a refrigerant (for example, water, air, oil, or the like) flows is disposed in a bellows shape. On an end of the bottom wall 32 in the Y-axis minus direction, an inlet port 35 through which a refrigerant flows into the refrigerant pipe 34, and a discharge port 36 through which the refrigerant is discharged from the refrigerant pipe 34 are formed. A refrigerant supply device (not illustrated in the drawing) is connected to the inlet port 35 and the discharge port 36. A refrigerant supplied from the refrigerant supply device circulates such that the refrigerant returns to the refrigerant supply device via the inlet port 35, the refrigerant pipe 34, and the discharge port 36. Accordingly, the respective energy storage devices 10 on the bottom wall 32 are cooled.

The side wall 33 is a rectangular annular wall body extending in the Z-axis plus direction from an outer peripheral edge of the bottom wall 32, and is formed continuously with respect to the entire circumference of the bottom wall 32. The opening 31 is formed inside the side wall 33. A pair of gas discharge ports 37 is formed in a portion of the side wall 33 in the Z-axis minus direction. Out of the pair of gas discharge ports 37, one gas discharge port 37 is disposed at a corner portion in the Z-axis minus direction and in the X-axis minus direction, and the other 37 is disposed at a corner portion in the Z-axis minus direction and in the X-axis plus direction. The respective gas discharge ports 37 are portions that connect the inside and the outside of the case 2, and discharge a gas discharged from the respective energy storage device 10 to the outside of the case 2.

The lid body 40 is a member that closes the opening 31 of the case body 30. The case body 30 and the case lid body 40 are sealed (hermetically sealed) by being joined by welding, fusion bonding, screwing, or the like. The case body 30 and the case lid body 40 may be made of the same material or may be made of different materials.

The energy storage device 10 is a secondary battery, and more specifically, is a nonaqueous electrolyte secondary battery such as a lithium ion secondary battery. The energy storage device 10 has a shape where a length of the energy storage device 10 in the X axis direction is longer than a length of the energy storage device 10 in the Y axis direction. Specifically, the energy storage device 10 has a rectangular parallelepiped shape (angular shape, angular type) that is flat in the Y axis direction. In this embodiment, eight energy storage devices 10 are arrayed side by side in the Y axis direction. The size of the energy storage device 10 and the number of arrayed energy storage devices 10 are not limited.

The spacer 20 is a member that is a member disposed side by side with the energy storage device 10 in the Y-axis direction, and provides electricity insulation and/or heat insulation between the energy storage device 10 and other member. The spacer 20 is an electricity insulating plate or a heat insulating plate that is disposed adjacently to the energy storage device 10, and provides electricity insulation and/or heat insulation between the energy storage devices 10 or between the energy storage device 10 and the case 2. The spacer 20 is formed of an insulating member made of a resin material or the like, a member having heat insulating property such as mica, or the like.

Among the spacers 20, the spacer 20 disposed between the energy storage devices 10 arrayed adjacently to each other forms an intermediate spacer. Two spacers 20 disposed at end portions of the plurality of energy storage devices 10 in the Y axis direction form end spacers. The spacer 20 has an outer profile based on a flat rectangular parallelepiped shape. Specifically, the spacer 20 has a shape based on an elongated rectangular shape in the X-axis direction as viewed in the Y-axis direction, and the respective corner portions of the rectangular shape are cut out in a rectangular shape so as to form the spacer recessed portions 21. The respective spacer recessed portions 21 correspond to the respective recessed portions (second recessed portions 101 and first recessed portions 102: described later) formed in the container 100 of the energy storage device 10. Accordingly, in a stacked body where the respective spacers 20 and the respective energy storage devices 10 are arrayed in the Y axis direction in an overlapping manner, the recessed portions of the respective energy storage devices 10 and the spacer recessed portions 21 of the respective spacers 20 are continuously arrayed in the Y axis direction. That is, in the stacked body, a first space S1 is formed at a corner portion in the Z-axis plus direction and the X-axis minus direction, a second space S2 is formed at a corner portion in the Z-axis plus direction and the X-axis plus direction, a third space S3 is formed at a corner portion in the Z-axis minus direction and the X-axis minus direction, and a fourth space S4 is formed at a corner portion in the Z-axis minus direction and the X-axis plus direction. Each of the first space S1 to the fourth space S4 extends in the Y-axis direction. Bus bars are disposed in the first space S1 and the second space S2. The third space S3 and the fourth space S4 serve as flow paths for a gas discharged from the respective energy storage devices 10. The third space S3 and the fourth space S4 are connected to the outside of the case 2 through the respective gas discharge ports 37. The refrigerant pipe 34 in the case body 30 is also disposed at positions corresponding to the third space S3 and the fourth space S4. That is, the refrigerant pipe 34 is an example of a cooling unit that cools the third space S3 and the fourth space S4.

The pair of gas discharge members 50 is disposed in the third space S3 and the fourth space S4. The gas discharge members 50 are members that each form a part of a gas flow path. To be more specific, each gas discharge member 50 is a member that covers gaps each of which is formed between each energy storage device 10 and each spacer 20 in the third space S3 or the fourth space S4. Details of the gas discharge member 50 will be described later.

The bus bars are connected (joined) to the terminals 300 of the energy storage devices 10. To be more specific, the plurality of bus bars connect the terminals 300 of the plurality of energy storage devices 10 to each other, and electrically connect the terminals 300 of the energy storage devices 10 at the end portions to the external terminals. The bus bars and the terminals 300 are connected (joined) to each other by welding or the like. However, a connection mode of the bus bars and the terminals 300 is not particularly limited. The bus bar is formed of a conductive member made of metal such as aluminum, an aluminum alloy, copper, a copper alloy, nickel, a conductive member made of the combination of these metals, or a conductive member made of a material other than metal.

### [Description of Energy Storage Device]

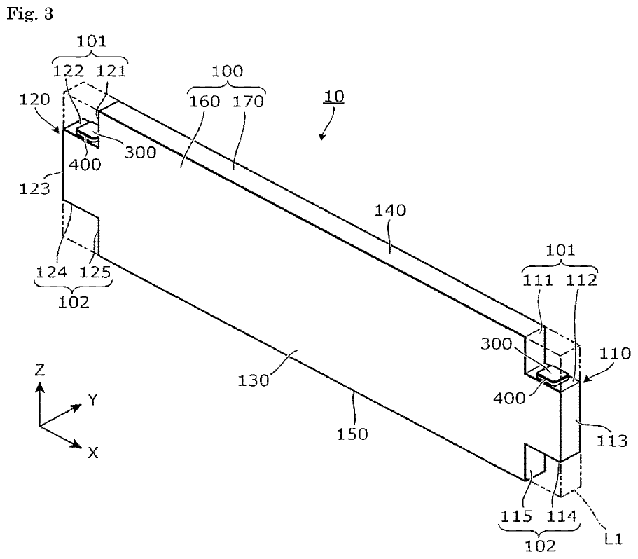

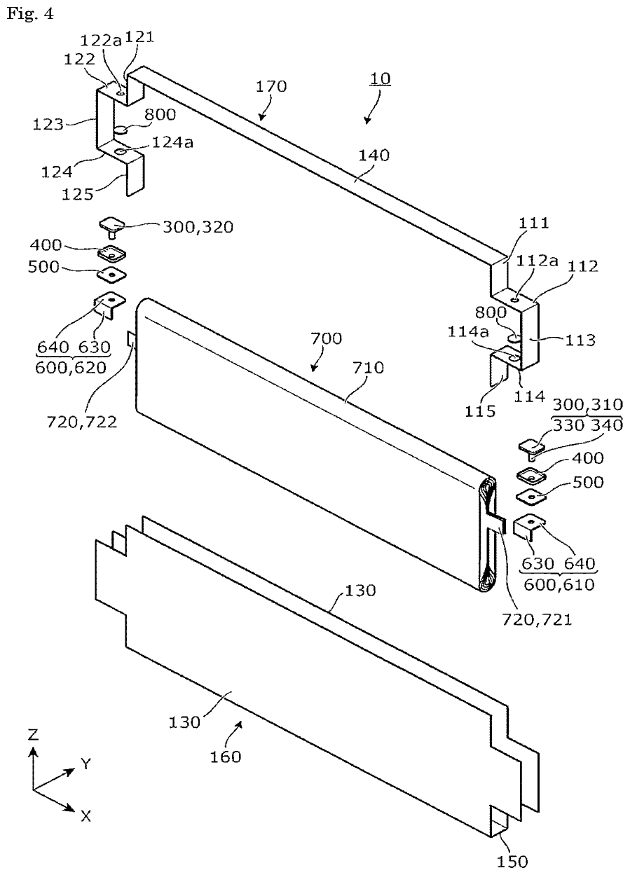

The energy storage device 10 according to the embodiment is described with reference to FIG. 3 and FIG. 4. FIG. 3 is a perspective view illustrating an external appearance of the energy storage device 10 according to the embodiment. FIG. 4 is an exploded perspective view of the energy storage device 10 according to the embodiment illustrating respective constitutional elements in a state where the energy storage device 10 is disassembled.

In this embodiment, the energy storage device 10 has a substantially rectangular parallelepiped shape. The energy storage device 10 is not limited to a nonaqueous electrolyte secondary battery. The energy storage device 10 may be a primary battery. Still further, the energy storage device 10 may be a pouch-type energy storage device. In the embodiment, the energy storage device 10 having a flat rectangular parallelepiped shape (substantially rectangular parallelepiped shape) as a reference shape is illustrated.

As illustrated in FIG. 3 and FIG. 4, the energy storage device 10 includes: a container 100; a pair of terminals 300; and a pair of outer gaskets 400. A pair of inner gaskets 500, a pair of current collectors 600, and an electrode assembly 700 are accommodated in the container 100. To be more specific, respective members of a positive electrode (the terminal 300, the outer gasket 400, the inner gasket 500, the current collector 600 and the like) are disposed on the first side surface portion 110 of the container 100 in the positive direction of the X axis. The same definition of the configuration of the members is also adopted in the description made hereinafter. On a second side surface portion 120 of the container 100 in the X-axis minus direction, respective members of a negative electrode are disposed.

An electrolytic solution (a non-aqueous electrolyte) is sealed in the container 100. However, the illustration of the electrolytic solution is omitted. A kind of the electrolyte solution is not particularly limited provided that the performance of the energy storage device 10 is not impaired, and various kinds of electrolyte solutions can be selected as the electrolyte solution used in the embodiment.

The container 100 is a case having a profile (substantially rectangular parallelepiped shape) using a flat rectangular parallelepiped shape that is elongated in the X-axis direction as the reference. For example, a length of the container 100 in the X-axis direction is set 3 times or more as long as a length of the container 100 in the Z-axis direction. That is, with respect to the widest surface of the container 100, a length of a long side of the widest surface is 3 times or more a length of a short side of the widest surface. In FIG. 3, the rectangular parallelepiped shape that is used as the reference is indicated by a double-dashed chain line L1. The container 100 has a profile where a cutout having a rectangular shape is formed on upper and lower portions of both end portions of the container 100 in the X-axis direction having a rectangular parallelepiped shape elongated in the X-axis direction respectively. It can also be said that each cutout forms a recessed portion as viewed in consideration of a rectangular parallelepiped shape that forms the reference. Among the plurality of cutouts, a pair of cutouts positioned at an upper portion of the container 100 forms a second recessed portion 101 respectively. A pair of cutouts positioned at a lower portion of the container 100 forms a first recessed portions 102 respectively. That is, on each of the first side surface portion 110 and the second side surface portion 120 of the container 100, the second recessed portion 101 and the first recessed portion 102 are formed so as to be disposed adjacently to each other in the Z-axis direction. The terminal 300 is disposed in the second recessed portion 101. A gas release valve 800 (see FIG. 4) is disposed in the first recessed portion 102. The gas release valve 800 is a safety valve that releases a pressure in the container 100 when such a pressure is excessively increased. Details of the gas release valve 800 is described later.

The first side surface portion 110 has the first upper side surface 111, the first upper surface 112, the first intermediate side surface 113, the first lower surface 114, and the first lower portion side surface 115. A first upper side surface 111 is disposed at an upper portion of the first side surface portion 110. The first upper side surface 111 is a flat surface having a rectangular shape that is parallel to a YZ plane. The first upper surface 112 is a flat surface extending in the X-axis plus direction from a lower end of the first upper side surface 111. The first upper surface 112 is a flat surface having a rectangular shape that is parallel to the XY plane. A first intermediate side surface 113 is a flat surface extending downward from an end portion of the first upper surface 112 in the X-axis plus direction. The first intermediate side surface 113 is a flat surface having a rectangular shape that is parallel to the YZ plane. A first lower surface 114 is a flat surface extending in the X-axis minus direction from a lower end of the first intermediate side surface 113. The first lower surface 114 is a flat surface having a rectangular shape and is parallel to the XY plane. A first lower portion side surface 115 is a flat surface extending downward from an end portion of the first lower surface 114 in the X-axis minus direction. The first lower portion side surface 115 is a flat surface having a rectangular shape and is parallel to the YZ plane.

The second recessed portion 101 of the first side surface portion 110 is defined by the first upper side surface 111 and the first upper surface 112. The first recessed portion 102 of the first side surface portion 110 is defined by the first lower surface 114 and the first lower portion side surface 115. Accordingly, an end portion of the first side surface portion 110 in the Z-axis plus direction (a corner portion of the container 100 in the X-axis plus direction and in the Z-axis plus direction) is formed in a shape where surfaces extending in the X-axis direction and the Z-axis direction are recessed and the shape penetrates in the Y-axis direction. In such a configuration, the Y-axis direction can be said to be the thickness direction of the container 100. On the other hand, also the end portion of the first side surface portion 110 in the Z-axis minus direction (a corner portion of the container 100 in the X-axis plus direction and in the Z-axis minus direction) is formed in a shape where wall surfaces extending in the X-axis direction and the Z-axis direction are recessed thus defining a shape that penetrates in the Y-axis direction. In other words, the second recessed portion 101 of the first side surface portion 110 is a recessed portion where a corner portion of the container 100 in the X-axis plus direction and in the Z-axis plus direction is recessed (cut out) in a quadrangular shape (L shape) as viewed in the Y-axis direction. The first recessed portion 102 of the first side surface portion 110 is a recessed portion where a corner portion of the container 100 in the X-axis plus direction and in the Z-axis minus direction is recessed (cut out) in a quadrangular shape (L shape) as viewed in the Y-axis direction.

The second side surface portion 120 has the same structure as the first side surface portion 110. The second side surface portion 120 includes a second upper side surface 121, a second upper surface 122, a second intermediate side surface 123, a second lower surface 124, and a second lower side surface 125. The second recessed portion 101 of the second side surface portion 120 has the same structure as the second recessed portion 101 of the first side surface portion 110. The second side surface portion 120 is defined by the second upper side surface 121 and the second upper surface 122. The first recessed portion 102 of the second side surface portion 120 has the same structure as the first recessed portion 102 of the first side surface portion 110. The first recessed portion 102 is defined by the second lower surface 124 and the second lower side surface 125.

In the container 100, both end surfaces that face each other in the Y-axis direction each form a long side surface 130. Each long side surface 130 is a plane parallel to the XZ plane and elongated in the X-axis direction. Both end portions of the container 100 in the X axis direction have shapes corresponding to the first side surface portion 110 and the second side surface portion 120. A direction along which the pair of long side surfaces 130 faces each other is a thickness direction of the container 100.

With respect to both end surfaces of the container 100 that face each other in the Z-axis direction, the end surface of the container 100 in the Z-axis plus direction is a top surface 140, and the end surface of the container 100 in the Z-axis minus direction is a bottom surface 150. The top surface 140 is a flat surface having a rectangular shape that parallel to the XY plane. The top surface 140 connects an upper end of the first upper side surface 111 of the first side surface portion 110 and an upper end of the second side surface 121 of the second side surface portion 120. The bottom surface 150 is a flat surface having a rectangular shape parallel to the XY surface. The bottom surface 150 connects a lower end of the first lower portion side surface 115 of the first side surface portion 110 and a lower end of the second lower side surface 125 of the second side surface portion 120.

The container 100 includes a container body 160 and a lid body 170. The container body 160 has the pair of long side surfaces 130 and the bottom surface 150. The lid body 170 has the first upper side surface 111, the first upper surface 112, the first intermediate side surface 113, the first lower surface 114, the first lower portion side surface 115, the second upper side surface 121, the second upper surface 122, the second intermediate side surface 123, the second lower surface 124, the second lower side surface 125, and the top surface 140.

Specifically, the container body 160 is a substantially U-shaped sheet metal with an upper side thereof opened as viewed in the X-axis direction. The container body 160 includes: flat plate-shaped long side wall portions that form the pair of the long side surfaces 130 at both end portions thereof in the Y-axis direction; and a flat plate-shaped rectangular bottom wall portion that forms the bottom surface 150 at an end portion in the Z-axis minus direction.

The lid body 170 is a sheet metal with a lower side thereof opened as viewed in the Y-axis direction. The lid body 170 has, at an end portion in the X-axis plus direction, a bent plate portion that forms the first upper side surface 111, the first upper surface 112, the first intermediate side surface 113, the first lower surface 114, and the first lower portion side surface 115. The lid body 170 has, at an end portion in the Z-axis plus direction, a bent plate portion that forms the second upper side surface 121, the second upper surface 122, the second intermediate side surface 123, the second lower surface 124, and the second lower side surface 125. The lid body 170 has a top wall portion having a rectangular shape that forms the top surface 140 at the end of the lid body 170 in the Z-axis plus direction.

After accommodating the electrode assembly 700 and the like in the container body 160, the container body 160 and the inside of the container 100 is sealed by joining the container body 160 and the lid body 170 to each other thus sealing the inside of the container 100. A material of the container 100 (the container body 160 and the lid body 170) is not particularly limited. However, for example, it is preferable that the container 100 be made of weldable metal such as stainless steel, aluminum, an aluminum alloy, iron, or a plated steel plate.

Although not illustrated in the drawing, a solution filling portion is formed in the lid body 170. The solution filling portion is a portion for filling an electrolyte solution into the container 100 at the time of manufacturing the energy storage device 10.

The terminals 300 are terminals (a positive electrode terminal 310 and a negative electrode terminal 320) that are electrically connected to the electrode assembly 700 via the current collectors 600. The terminals 300 are metal-made members that are provided for discharging electricity stored in the electrode assembly 700 to an external space of the energy storage device 10, or, for charging electricity into an internal space in the energy storage device 10 so as to store electricity in the electrode assembly 700. Materials of the terminals 300 are not particularly limited. For example, the terminals 300 (the positive electrode terminal 310 and the negative electrode terminal 320) are respectively formed using aluminum, an aluminum alloy, copper, a copper alloy or the like. The terminals 300 are connected (joined) to the current collectors 600 by crimping, welding or the like. Further, the terminals 300 are mounted on the lid body 170.

In this embodiment, the terminals 300 include a terminal body portion 330 and a shaft portion 340 that protrudes from the terminal body portion 330. The terminal body portion 330 is a portion of the container 100 that protrudes outward from a terminal mounting surface of the container 100. In this embodiment, the terminal mounting surface is formed of the first upper surface 112 or the second upper surface 122. In any terminal mounting surface, the terminal body portion 330 protrudes outward from the container 100 along the Z-axis direction. Through holes 112a, 122a through which the shaft portion 340 passes are formed in the lid body 170 at positions that correspond to the respective terminal mounting surfaces. The shaft portion 340 is connected (joined) to the current collector 600 by crimping in a state where the shaft portion 340 penetrates the terminal mounting surface, the outer gasket 400, the inner gasket 500 and the current collector 600.

The current collectors 600 are provided such that one current collector 600 is disposed on each of both sides of the electrode assembly 700 in the X-axis direction, and are connected (joined) to the electrode assembly 700 and the terminals 300. The current collectors 600 are members (positive electrode current collector 610 and the negative electrode current collector 620) having conductivity that electrically connect the electrode assembly 700 and the electrode terminals 300 to each other. To be more specific, the current collector 600 integrally includes a first joining portion 630 where the current collector 600 is connected (joined) to the tab portion 720 of the electrode assembly 700, and a second joining portion 640 where the electrode assembly 700 is connected (joined) to the terminal 300. The first joining portion 630 and the second joining portion 640 are each a flat plate-like portion. The first joining portion 630 and the second joining portion 640 are formed by bending one sheet metal. Although a material of the current collector 600 is not particularly limited. However, for example, the positive electrode current collector 610 is formed of a conductive member made of aluminum or an aluminum alloy or the like. The negative electrode current collector 620 is formed of a conductive member made of copper or a copper alloy or the like.

The outer gasket 400 is disposed between the lid body 170 of the container 100 and the terminal 300. The outer gasket 400 provides insulation and sealing between the lid body 170 and the terminal 300. The inner gasket 500 is disposed between the lid body 170 and the current collector 600. The inner gasket provides insulation and sealing between the lid body 170 and the current collector 600.

The electrode assembly 700 is an energy storage element (a power generating element) that is formed by winding plates and can store electricity. The electrode assembly 700 has an elongated shape extending in the X-axis direction, and has an elongated circular shape as viewed in the X-axis direction. The electrode assembly 700 has a shape where a length in the X-axis direction is, for example, 300 mm or more, and more specifically, about 500 mm to 1500 mm. With such a configuration, the length of the electrode assembly 700 in the X-axis direction is set larger than the length of the electrode assembly 700 in the Z-axis direction. For example, the length of the electrode assembly 700 in the X-axis direction is 3 times or more as large as the length of the electrode assembly 700 in the Z-axis direction. The electrode assembly 700 includes a body portion 710 and a plurality of tab portions 720 protruding from the body portion 710. As described above, the tab portions 720 are connected (joined) to the current collectors 600. The tab portion 720 is an example of a connecting portion that is connected to the current collector 600.

Specifically, with respect to the plurality of tab portions 720, one tab portion 720 protrudes from each of both end surfaces of the body portion 710 in the X-axis direction. For example, the positive electrode tab portion 721 is formed on one end surface of the body portion 710 in the X-axis plus direction, and the negative electrode tab portion 722 is formed on the other end surface of the body portion 710 in the X-axis minus direction.

### [Description of Configuration of Electrode Assembly]

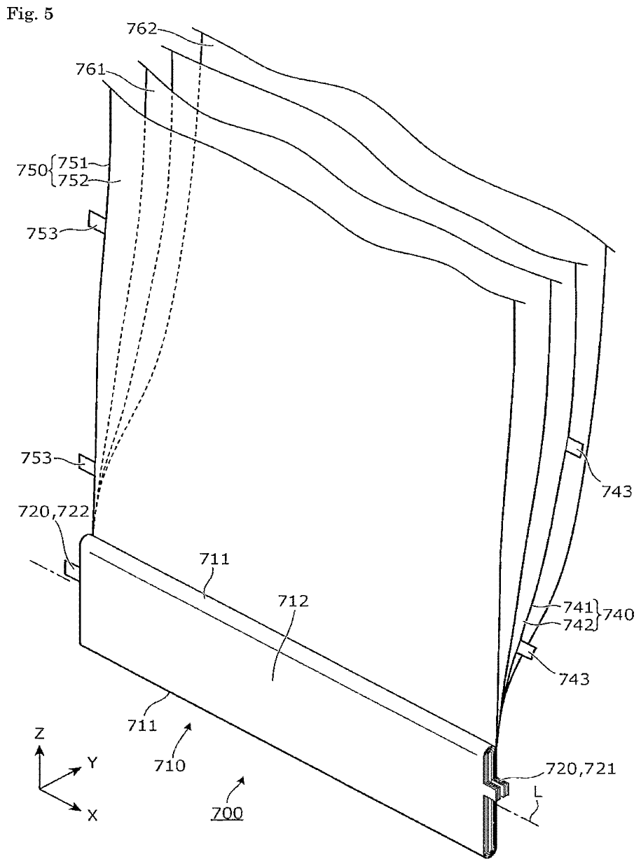

FIG. 5 is a perspective view illustrating the configuration of the electrode assembly 700 according to the embodiment. Specifically, FIG. 5 illustrates the configuration of the winding state of plates in the electrode assembly 700 in a state where the winding state of the plates is partially developed. As illustrated in FIG. 5, the electrode assembly 700 includes a positive plate 740, a negative plate 750, and separators 761, 762.

The positive plate 740 is a plate (electrode plate) where a positive active material layer 742 is formed on a surface of a positive electrode substrate 741. The positive electrode substrate 741 is an elongated strip-shaped metal foil made of aluminum, an aluminum alloy, or the like. The negative plate 750 is a plate (electrode plate) where a negative active material layer 752 is formed on a surface of a negative electrode substrate 751. The negative electrode substrate 751 is an elongated strip-shaped metal foil made of copper, a copper alloy, or the like. As the positive active material used for forming the positive active material layer 742 and the negative active material used for forming the negative active material layer 752, known materials can be appropriately used provided that these materials can occlude and discharge lithium ions.

For example, as the positive active material, a polyanion compound such as LiMPO₄ (M representing one kind or two or more kinds of transition metal elements selected from Fe, Ni, Mn, Co, and the like), a lithium transition metal oxide such as LiMn₂O₄ or LiMO₂ (M representing one kind or two or more kinds of transition metal elements selected from Fe, Ni, Mn, Co, and the like), or the like can be used. As examples of the negative electrode active material, lithium metal, a carbon material (for example, graphite, non-graphitizable carbon, easily graphitizable carbon, and the like) can be named.

The separators 761, 762 are each formed of a microporous sheet made of a resin. For example, as the separators 761 and 762, a woven fabric that is insoluble in an organic solvent, a nonwoven fabric, a synthetic resin microporous membrane made of a polyolefin resin such as polyethylene, or the like can be used.

The electrode assembly 700 is formed by alternately stacking and winding the positive plate 740, the negative plate 750, and the separators 761, 762. That is, the electrode assembly 700 is formed by stacking and winding the negative plate 750, the separator 761, the positive plate 740, and the separator 762 in this order. In this embodiment, the electrode assembly 700 is a winding-type electrode assembly formed by winding the positive plate 740, the negative plate 750 and the like around a winding axis L extending in the X-axis direction. The winding axis L is a virtual axis that becomes a center axis when the positive plate 740, the negative plate 750 and the like are wound, and in this embodiment, the winding axis L is a straight line that passes through the center of the electrode assembly 700 and is parallel to the X-axis direction.

On an end edge of the positive plate 740 in the X-axis plus direction, a plurality of protruding members 743 that respectively protrude outward are formed at intervals. In the same manner, on an end edge of the negative plate 750 in the X-axis minus direction, a plurality of protruding members 753 that respectively protrude outward are disposed at intervals. Each of the protruding members 743 and 753 is a portion where an active material layer that contains an active material is not formed so that a substrate layer is exposed (an active material layer-non-formed portion).

When the positive plate 740, the negative plate 750, and the separators 761 and 762 are wound, the respective protruding members 743 of the positive plate 740 overlap with each other on one end surface of the body portion 710, and the respective protruding members 753 of the negative plate 750 overlap with each other on the other end surface of the body portion 710. A portion where the respective protruding members 743 of the positive plate 740 overlap with each other forms the positive electrode tab portion 721. That is, the positive electrode tab portion 721 is a portion formed by stacking a plurality of protruding members 743 of the positive plate 740. In the same manner, a portion where the respective protruding members 753 of the negative plate 750 overlap with each other forms the negative electrode tab portion 722. That is, the negative electrode tab portion 722 is a portion formed by stacking a plurality of protruding members 753 of the negative plate 750.

As described above, the electrode assembly 700 includes: the body portion 710 that forms a body of the electrode assembly 700; and the plurality of tab portions 720 (the positive electrode tab portion 721 and the negative electrode tab portion 722) that protrude as a pair from both end surfaces of the body portion 710 in the X-axis direction respectively.

The body portion 710 is an elongated circular columnar portion (an active material layer forming portion) that is formed by winding the positive active material layer 742 of the positive plate 740, the negative active material layer 752 of the negative plate 750 and the separators 761, 762 together. With such a configuration, the body portion 710 has a pair of curved portions 711 on both sides in the Z-axis direction, and a flat portion 712 having a flat shape is formed between the pair of curved portions 711. It can also be said that the pair of curved portions 711 is disposed at positions that sandwich the flat portion 712 in the Z-axis direction.

The curved portion 711 is a curved portion that is curved in an arc shape in the Z-axis direction as viewed in the X-axis direction and extends in the X-axis direction. The curved portions 711 are disposed so as to face the bottom wall portion of the container body 160 and the top wall portion of the lid body 170. That is, the pair of curved portions 711 is portions that is curved so as to protrude from the flat portion 712 toward the bottom wall portion of the container body 160 and the top wall portion of the lid body 170 as viewed in the X-axis direction, that is, toward both sides of the body portion 710 from the flat portion 712 in the Z-axis direction.

The flat portion 712 is a flat portion having a rectangular shape that connects the end portions of the pair of curved portions 711 to each other and extends parallel to the XZ plane directed in the Y-axis direction. The flat portion 712 is disposed so as to face the long side wall portions of the container body 160 on both sides in the Y axis direction. In the flat portion 712, a plurality of wound plates (the positive plate 740 and the negative plate 750) are stacked in the Y-axis direction. That is, in the flat portion 712, the Y-axis direction is a stacking direction of the plurality of plates. In this embodiment, the main stacking direction of the electrode assembly 700 is defined as the Y-axis direction.

The curved shape of the curved portion 711 is not limited to a semicircular arc shape, and may be a part of an elliptical shape or the like. That is, the curved shape may be curved in any shape. The flat portion 712 is not limited to a shape where outer surfaces of the flat portion 712 directed in the Y-axis direction are formed of a flat surface, and the outer surfaces may be slightly recessed or may be slightly bulged.

### [Gas Release Valve]

The gas release valve 800 is in the first recessed portion 102 of each of the first side surface portion 110 and the second side surface portion 120. Specifically, as illustrated in FIG. 4, a hole 114a that penetrates the first side surface portion 110 in the Z-axis direction is formed in the first lower surface 114 of the first side surface portion 110 of the lid body 170, and the gas release valve 800 is mounted so as to close the hole 114a. In the same manner, as illustrated in FIG. 4, a hole 124a that penetrates the second side surface portion 120 in the Z-axis direction is formed in the second lower surface 124 of the second side surface portion 120 of the lid body 170, and the gas release valve 800 is mounted so as to close the hole 124a. Hereinafter, the specific structure of the gas release valve 800 is described by exemplifying the first recessed portion 102 formed in the first side surface portion 110. However, the structure of the gas release valve 800 is substantially the same also with respect to the first recessed portion 102 of the second side surface portion 120 and hence, the description of the structure where the gas release valve 800 closes the hole 124a is omitted.

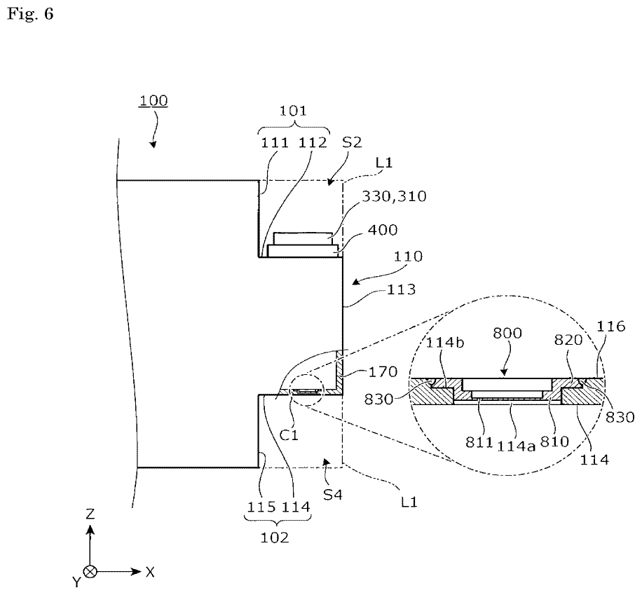

FIG. 6 is a plan view illustrating the first side surface portion 110 according to the embodiment. In FIG. 6, a portion of the first recessed portion 102 of the first side surface portion 110 is illustrated in a cross section, and a portion that is surrounded by a circle C1 is illustrated in an enlarged manner. Also in FIG. 6, a rectangular parallelepiped shape of the container 100 that is used as a reference is indicated by a double-dashed chain line L1. In the second recessed portion 101, a space surrounded by the first upper side surface 111, the first upper surface 112, and the double-dashed chain line L1 forms the second space S2. In the first recessed portion 102, a space surrounded by the first lower surface 114, the first lower portion side surface 115, and the double-dashed chain line L1 forms the fourth space S4.

The hole 114a is formed in the first lower surface 114 of the lid body 170. To be more specific, a large-diameter portion 114b that is disposed coaxially with the hole 114a and has a larger inner diameter than the hole 114a is formed in a first inner surface 116 that is a portion of an inner surface of the first lower surface 114 of the lid body 170.

The gas release valve 800 is a metal-made member having a substantially disk shape formed by using weldable metal such as, for example, stainless steel, aluminum, an aluminum alloy, iron or a plated steel plate. To be more specific, the gas release valve 800 is formed in a circular shape as viewed in the Z-axis direction, and a center portion of the gas release valve 800 protrudes in a circular shape. The center portion that protrudes in a circular shape forms a fitting engagement portion 810, and a portion outside the center portion forms an outer edge portion 820.

The fitting engagement portion 810 is a portion fitted to the hole 114a over the entire circumference. A center portion of the fitting engagement portion 810 is formed of a thin wall portion 811 having a smaller wall thickness than other portions of the fitting engagement portion 810. A thin wall portion 811 is a valve element that, in a case where a pressure inside the container 100 is excessively increased, is torn and opened by the pressure. The thin wall portion 811 is disposed between the first lower surface 114 and the first inner surface 116 of the lid body 170. As described above, the thin wall portion 811 is disposed at the position deeper than the first lower surface 114 and the first inner surface 116 of the lid body 170 respectively. Accordingly, the thin wall portion 811 is minimally damaged and hence, reliability of the thin wall portion 811 as the valve element is enhanced.

The outer edge portion 820 is a portion that is inserted into the large-diameter portion 114b. That is, the large-diameter portion 114b is an example of a recessed portion into which the outer edge portion 820 of the gas release valve 800 is inserted. In a state where the outer edge portion 820 is inserted into the large-diameter portion 114b, the outer edge portion 820 is disposed outside a peripheral edge of the hole 114a as viewed in the axial direction of the hole 114a (as viewed in the Z-axis direction). Even if a pressure in the container method is excessively increased so that the gas release valve 800 receives such an increased pressure, the outer edge portion 820 is caught by the large-diameter portion 114b and hence, the removal of the gas release valve 800 can be suppressed. As a result, the gas release valve 800 is minimally removed from the lid body 170 before the gas release valve 800 opens.

In this embodiment, the case is exemplified where the outer edge portion 820 engages with the large-diameter portion 114b by fitting engagement over the entire circumference. However, the outer edge portion 820 may not engage with the large-diameter portion 114b by fitting engagement. The outer edge portion 820 is welded to the first inner surface 116 of the container 100 in a state where the outer edge portion 820 is disposed coplanar (flush) with the first inner surface 116 of the lid body 170. In FIG. 6, a welded portion 830 between the outer edge portion 820 and the lid body 170 is illustrated by dotted hatching. The welded portion 830 is continuously formed over the entire circumference of the outer edge portion 820. With such a configuration, the gas release valve 800 and the lid body 170 are sealed (hermetically sealed) with each other. As described above, the outer edge portion 820 of the gas release valve 800 and the first inner surface 116 of the lid body 170 are disposed coplanar with each other and hence, a weld penetration depth by welding can be set to a stable value.

### [Gas Discharge Member]

As illustrated in FIG. 2, each gas discharge member 50 is formed of a sheet metal member elongated in the Y-axis direction. One gas discharge member 50 is disposed in the third space S3, and the other gas discharge member 50 is disposed in the fourth space S4. The respective gas discharge members 50 has substantially the same structure. Accordingly, in this embodiment, the description is made by exemplifying the gas discharge member 50 disposed in the fourth space S4.

The gas discharge member 50 includes: a first plate portion 51; and a second plate portion 52 that is bent with respect to the first plate portion 51. The first plate portion 51 is a rectangular plate-like portion disposed parallel to the YZ plane. The second plate portion 52 is a rectangular plate-like portion disposed parallel to the XY plane. The first plate portions 51 overlap with portions of the first recessed portions 102 of the respective energy storage devices 10, and portions of the spacer recessed portions 21 of the respective spacers 20. The second plate portions 52 overlap with another portions of the first recessed portions 102 of the respective energy storage devices 10, and another portions of the spacer recessed portions 21 of the respective spacers 20. With such a configuration, in the fourth space S4, gaps each formed between the energy storage device 10 and the spacer 20 that are disposed adjacently to each other are covered by the first plate portion 51 and the second plate portion 52.

A plurality of vent holes 53 are formed in the second plate portion 52 at positions corresponding to the gas release valves 800 of the respective energy storage devices 10. For example, when the gas release valve 800 of a predetermined energy storage device 10 is opened so that a gas is discharged, the gas enters the fourth space S4 through the vent hole 53. In such a configuration, it is preferable that the vent hole 53 be set larger than the gas release valve 800 in size. An annular seal member that is interposed between the second plate portion 52 and the energy storage device 10 may be disposed around the vent holes 53. The seal member is formed using, for example, rubber or a porous resin. The seal member prevents a gas from leaking to the outside of the fourth space S4. In a state where a gas flows through the fourth space S4, the gas is cooled by a refrigerant that flows through the refrigerant pipe 34 and then, is discharged from the gas discharge port 37. In such a case, the gas discharge member 50 covers the gaps each formed between the energy storage device 10 and the spacer 20 disposed adjacently to each other. Accordingly, it is possible to suppress the intrusion of a gas into the gaps. In this embodiment, the gas discharge member 50 having an L shape as viewed in the Y-axis direction is exemplified. However, the gas discharge member 50 may have a U shape or an angular tube shape. The gas discharge member 50 can take any shape so long as the vent hole is formed at a position corresponding to the gas release valve of each energy storage device.

As illustrated in FIG. 6, the energy storage device 10 according to this embodiment includes, in addition to the first recessed portion 102 where the gas release valve is disposed, the second recessed portion 101 where the terminal 300 is disposed is formed. The energy storage device 10 according to this embodiment includes the container 100 that accommodates the electrode assembly 700. The container 100 has the second recessed portion 101 (recessed portion) in a portion of a corner portion of a surface of the container 100 as viewed in a thickness direction of the container 100. The second recessed portion 101 penetrates in the thickness direction, and the terminal 300 is disposed in the second recessed portion 101.

With such a configuration, as compared with the configuration where the terminal 300 is formed on the upper surface of the container 100, a height (a length in the Z-axis direction) of the energy storage device 10 can be lowered by accommodating the terminal in the second recessed portion 101. As a result, the energy density of the energy storage device 10 can be increased. In addition, by accommodating the terminal 300 in the second recessed portion 101, it is possible to protect the periphery of the terminal 300 when the energy storage device 10 receives an impact caused by collision, falling, or the like. As a result, the possibility of the occurrence of short-circuiting can be reduced. In this embodiment, to achieve these effects based on the provision of the terminal 300 in the second recessed portion 101, it is not always necessary that the first recessed portion 102 exists.

In the energy storage apparatus 1 according to this embodiment, as shown in FIG. 2, a plurality of energy storage devices each of which includes the second recessed portion 101 (recessed portion on the upper side of the Z-axis) are arrayed in the thickness direction. The energy storage apparatus 1 according to this embodiment includes: the plurality of energy storage devices 10; and the case 2 (outer case) that accommodates the plurality of energy storage devices 10. The energy storage device 10 according to this embodiment includes the container 100 that accommodates the electrode assembly 700. The container 100 has the second recessed portion 101 (recessed portion) in the portion of the corner portion of the surface of the container 100 as viewed in a thickness direction of the container 100. The second recessed portion 101 penetrates in the thickness direction, and the terminal 300 is disposed in the second recessed portion 101. The plurality of energy storage devices 10 are arrayed in the thickness direction, and second the recessed portions 101 of the plurality of energy storage devices 10 communicate with each other in the thickness direction.

With such a configuration, as compared with the configuration where the terminal 300 is formed on the upper surface of the container 100, the terminal can be accommodated in the second recessed portion 101 and hence, a height (a length in the Z-axis direction) of the energy storage device 10 can be lowered. As a result, the energy density of the energy storage apparatus 1 can be increased. In addition, the terminal 300 is accommodated in the second recessed portion 101. Accordingly, it is possible to reduce a possibility of the occurrence of short-circuiting caused by falling of a tool or the like at the time of manufacturing the energy storage apparatus 1 or at the time of performing maintenance work of the energy storage apparatus 1. In this embodiment, to achieve these effects based on the provision of the terminal 300 in the second recessed portion 101, it is not always necessary that the first recessed portion 102 exists.

### [Description of Advantageous Effects]

As described above heretofore, according to the energy storage device 10 of the embodiment of the present invention, the energy storage device 10 includes the container 100 that accommodates the electrode assembly 700. The container 100, with respect to a surface thereof as viewed from a thickness direction (Y-axis direction of the container 100), has the first recessed portion 102 at a portion of the corner portion of the surface or at a portion of the side portion of the surface. The first recessed portion 102 penetrates the energy storage device 10 in the thickness direction, and the gas release valve 800 is disposed in the first recessed portion 102. With such a configuration, the first recessed portion 102 can be used for forming flow paths of a gas (third space S3, fourth space S4). For example, by accommodating energy storage devices 10 in the case 2, a gas flow paths can be easily formed by the first recessed portions 102.

The lid body 170 (a portion of the container 100) is made of metal. The gas release valve 800 is made of metal and is a member separate from the lid body 170. The hole 114a is formed in the first recessed portion 102. The gas release valve 800 closes the hole 114a and is joined to the lid body 170. With such a configuration, even with respect to the first recessed portion 102 that cannot be easily formed by press working, the gas release valve 800 can be easily mounted.

The gas release valve 800 includes the outer edge portion 820, the outer edge portion 820 is disposed outside the peripheral edge of the hole 114a as viewed from the penetrating direction of the hole 114a. The large-diameter portion 114b (recessed portion) that allows the insertion of the outer edge portion 820 therein is formed in the lid body 170 (portion of the container 100), and the outer edge portion 820 is welded to the lid body 170. With such a configuration, between the gas release valve 800 and the lid body 170 at the time of assembly can be performed easily.

The container 100 has the second recessed portion 101 at the corner portion of the surface of the container 100 as viewed from the thickness direction (Y-axis direction) of the container 100, and a terminal 300 is disposed in the second recessed portion 101. With such a configuration, as compared with the configuration where the terminal 300 is disposed on the upper surface of the container 100, the terminal 300 can be accommodated in the second recessed portion 101 and hence, a height (a length in the Z-axis direction) of the energy storage device 10 can be lowered. As a result, the energy density of the energy storage device 10 can be increased. In addition, by accommodating the terminal 300 in the second recessed portion 101, it is possible to protect the periphery of the terminal 300 when the energy storage device 10 receives an impact caused by collision, falling, or the like. As a result, the possibility of the occurrence of short-circuiting can be reduced. Further, the upper surface of the container 100 of the energy storage device 10 can be directly pressed by the case 2 (outer case). A reaction force of the energy storage device 10 can be received also by the case 2. And hence, there arises a possibility that the thickness of the container 100 can be reduced. As a result, the weight of the container 100 can be reduced.

The gas release valve is disposed in the first recessed portion 102 and the terminal 300 is disposed in the second recessed portion 101. The corner portion where the first recessed portion 102 is formed and the corner portion where the second recessed portion 101 is formed are disposed adjacently to each other on a surface as viewed from the thickness direction (Y-axis direction) of the container 100. With such a configuration, a gas diffusion path when a gas is discharged and an electricity supply path that includes the terminals 300 can be separated from each other. As a result, a possibility of occurrence of short-circuiting caused by a discharged metal piece or the like can be reduced. Further, a detection circuit disposed around the terminal 300 can be separated from the gas diffusion path As a result, it is possible to maintain the detection circuit in a normal state and hence, it is possible to easily discriminate the energy storage device in which a defect occurred.

The energy storage apparatus 1 includes: the plurality of energy storage devices 10 each having the first recessed portion 102 in the container 100; and the case 2 (outer case) that accommodates these plurality of energy storage devices 10. The plurality of energy storage devices are arrayed in the thickness direction, and the first recessed portions 102 of the plurality of energy storage devices 10 communicate with each other in the thickness direction. With such a configuration, the gas flow path formed of the respective first recessed portions 102 can be formed in the case 2. Also in this case, by simply accommodating the respective energy storage device 10 in the case 2, the gas flow path can be easily formed by the first recessed portion 102 and the case 2.

The refrigerant pipe 34 (cooling unit) is disposed at a position that faces the first recessed portion 102 of the case 2 (outer case). With such a configuration, the gas flowing through the first recessed portion 102 can be cooled by the refrigerant pipe 34. As a result, it is possible to suppress the normal energy storage device 10 from becoming a high temperature caused by a gas that flows in the flow path.

The energy storage apparatus 1 includes the discharge member 50 disposed in the first recessed portion 102, and the gas discharge member 50 is disposed over the plurality of energy storage devices 10 in the array direction of the plurality of energy storage devices 10. With such a configuration, the gaps each formed between the energy storage devices 10 disposed adjacently to each other can be covered by the gas discharge member 50. As a result, leaking of a gas that flows through the flow path from the first recessed portion 102 can be suppressed by the gas discharge member 50.

The energy storage apparatus 1 includes: the plurality of energy storage devices each of which includes the terminal 300 in the second recessed portion 101; and the case 2 (outer case) which accommodates the energy storage devices 10. The plurality of energy storage devices 10 are arrayed in a thickness direction of the energy storage devices 10, and second the recessed portions 101 of these plurality of energy storage devices communicate with each other in the thickness direction. With such a configuration, as compared with the configuration where the terminal is disposed on the upper surface of the energy storage device 10, the terminal 300 can be accommodated in the second recessed portion 101 and hence, a height (a length in the Z-axis direction) of the energy storage device 10 can be lowered. As a result, the energy density of the energy storage apparatus 1 can be increased. In addition, the terminal 300 is accommodated in the second recessed portion 101. Accordingly, it is possible to reduce a possibility of the occurrence of short-circuiting caused by falling of a tool or the like at the time of manufacturing the energy storage apparatus 1 or at the time of performing maintenance work of the energy storage apparatus 1.

The first recessed portion 102 is formed at the corner portion of the surface of the container 100 on the surface when viewed from a thickness direction (Y-axis direction). Accordingly, when the first recessed portion 102 is used as a gas flow path, two side surfaces of the flow path as viewed in a thickness direction (In FIG. 6, indicated by a double-dashed chain line L1 in the X-axis plus direction and a double-dashed chain line L1 in the Z-axis minus direction of the first recessed portion 102) can be disposed outside the container 100. Accordingly, these two side surfaces are not interrupted by the container 100 and hence, heat dissipation property of a gas flowing in the flow path can be enhanced.

The energy storage apparatus includes at least one spacer 20 disposed between the energy storage devices 10 disposed adjacently to each other out of the plurality of energy storage devices 10, and the spacer 20 includes a spacer recessed portion 21 at a portion that overlaps with a portion of the first recessed portion 102 in the thickness direction. With such a configuration, the spacer recessed portion 21 can be also used as a gas flow path. It is possible to prevent the spacer 20 from interrupting the flow of the gas while preventing a contact between the energy storage devices 10 by the spacer 20.

The gas release valve 800 is disposed on each of the first side surface portion 110 and the second side surface portion 120. Accordingly, even if the gas release valve 800 on one side is not opened due to a certain abnormality, the gas release valve 800 on the other side can be opened. Accordingly, stability of gas releasing can be enhanced. Particularly, in the energy storage device 10 elongated in the X-axis direction, the electrode assembly 700 is densely accommodated in the energy storage device 10. Accordingly, there is a possibility that a change in internal pressure in the container 100 is not evenly transmitted to both of the first side surface portion 110 and the second side surface portion 120. In this embodiment, the gas release valve 800 is disposed in the first side surface portion 110 and the second side surface portion 120 respectively. Accordingly, even when the gas release valve 800 on one side is not opened, the gas release valve 800 on the other side can be opened. It is sufficient that at least one gas release valve 800 is disposed in one energy storage device 10.

### [Description of Modifications]

Next, respective modifications of the above-mentioned embodiment will be described. In the following description, components identical to the components in the above-mentioned embodiment or other modifications are denoted by the same reference numerals, and the description of these components may be omitted. In the following description, the first side surface portion is described as an example. However, the second side surface portion also has substantially the same shape as the first side surface portion.

### Modification 1

Next, a modification 1 of the embodiment described above is described. In the above-described embodiment, the case where the gas release valve 800 is disposed on the first inner surface 116 of the lid body 170 has been exemplified. However, in this modification 1, a case is described where the gas release valve 800 is disposed on a first lower surface 1141 (outer surface) of a lid body 170c. FIG. 7 is a plan view illustrating a first side surface portion 110c according to the modification 1 of the embodiment. FIG. 7 is a view that corresponds to FIG. 6.

As illustrated in FIG. 7, on the first side surface portion 110c according to the modification 1, a large-diameter portion 114d is disposed on a first lower surface 1141 coaxially with a hole 114c, and the large-diameter portion 114d has a larger inner diameter than the hole 114c. The gas release valve 800 is configured such that a fitting engagement portion 810 engages with the hole 114c by fitting engagement in a state where an outer edge portion 820 is directed downward. The outer edge portion 820 engages with the large-diameter portion 114d by fitting engagement over the entire periphery. The outer edge portion 820 is welded to the first lower surface 1141. As described above, the gas release valve 800 is disposed on the first lower surface 1141 (outer surface) of the lid body 170c. Accordingly, the gas release valve 800 can be mounted on the first lower surface 1141 of the lid body 170c after the container body 160 and the lid body 170c are joined to each other.

In a method of manufacturing the energy storage device 10, the respective terminals 300, the respective current collectors 600, and the electrode assembly 700 are assembled to the lid body 170c, and, thereafter, the container body 160 and the lid body 170c are welded to each other. Next, an electrolyte solution is filled in the container 100 through the hole 114c, and, thereafter, the gas release valve 800 is disposed so as to close the hole 114c, and is joined to the lid body 170c. That is, after filling an electrolyte solution in the container 100 through the hole 114c, the hole 114c can be closed by the gas release valve 800. The hole 114c can be also used as an electrolyte solution filling port and hence, time and efforts for forming a hole that is dedicatedly used as an electrolyte solution filing port can be eliminated.

In a case where the gas release valve 800 is disposed on the inner surface of the container 100, it is necessary to join the gas release valve 800 before welding the gas release valve 800. In a case where welding is used for joining the gas release valve 800 and the container 100, there may be a case where a wall portion of the container on which the gas release valve 800 is mounted is deformed due to a thermal strain thus becoming an obstacle at the time of welding the container. In this modification, the gas release valve 800 is joined to the first lower surface 1141 (outer surface) of the lid body 170c and hence, welding of the container can be performed first whereby this drawback can be reduced.

### Modification 2

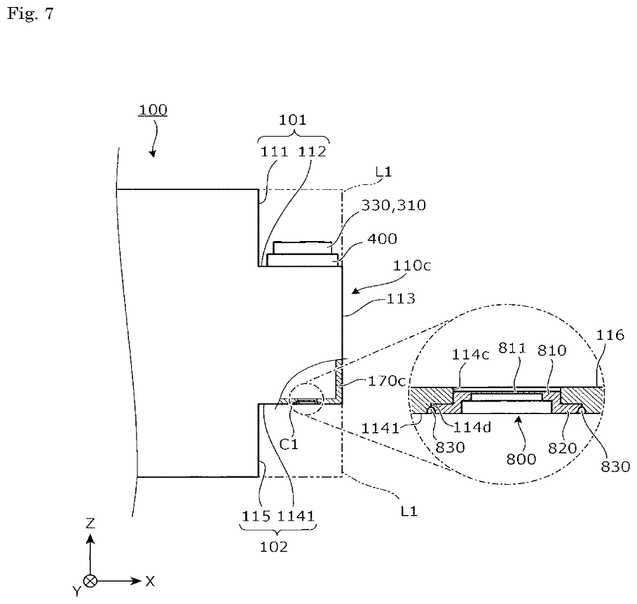

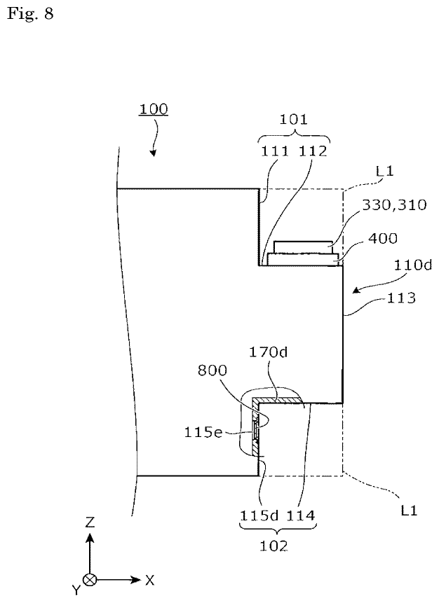

The modification 2 of the above-mentioned embodiment is described. In the above-described embodiment, the case has been described where the gas release valve 800 is disposed on the first lower surface 114 of the lid body 170. In modification 2, a case is described where the gas release valve 800 is disposed at a portion that corresponds to a first lower portion side surface 115d of the lid body 170d. FIG. 8 is a plan view illustrating a first side surface portion 110d according to the modification 2 of the embodiment. FIG. 8 is a view that corresponds to FIG. 6.

As illustrated in FIG. 8, a hole 115e that penetrates in the X axis direction is formed in the first lower portion side surface 115d of the lid body 170d. The gas release valve 800 is mounted on the portion so as to close the hole 115e. In this case, a vent hole is formed in a gas discharge member at a position corresponding to the gas release valve 800 of the energy storage device according to the modification 2.

### Modification 3

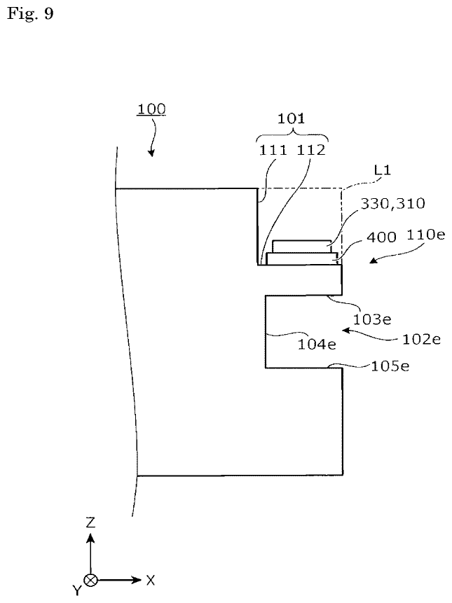

The modification 3 of the above-mentioned embodiment will be described. In the embodiment described above, the case has been exemplified where the first recessed portion 102 is formed on the end portion of the first side surface portion 110 in the Z axis minus direction. In the modification 3, the description is made with respect to a first side surface portion 110e where a first recessed portion 102e is formed in an intermediate portion in the Z axis direction. FIG. 9 is a plan view illustrating the first side surface portion 110e according to the modification 3 of the embodiment. FIG. 9 is a view that corresponds to FIG. 6.

As illustrated in FIG. 9, on an intermediate portion of the first side surface portion 110e in the Z-axis direction, a first recessed portion 102e having a rectangular shape as viewed in the Y-axis direction is formed. The first recessed portion 102e penetrates the first side surface portion 110e in the Y axis direction, and is opened in the X-axis plus direction. The first recessed portion 102e has a recessed-portion upper surface 103e, a recessed-portion side surface 104e, and a recessed-portion lower surface 105e. Although not illustrated, a gas release valve 800 is mounted on any one of the recessed-portion upper surface 103e, the recessed-portion side surface 104e, and the recessed-portion lower surface 105e. In this case, in a spacer, a spacer recessed portion is formed at a position corresponding to the first recessed portions 102e of the energy storage device according to the modification 3. A gas discharge member is formed in a shape corresponding to the first recessed portion 102e, and a vent is disposed at a position corresponding to the gas release valve 800.

### Modification 4

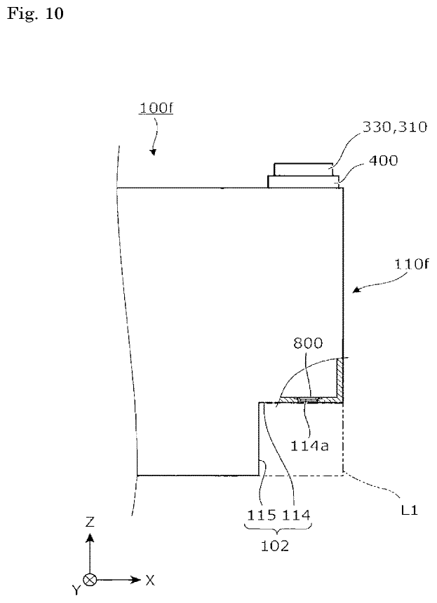

The modification 4 of the above-mentioned embodiment will be described. In the above embodiment, the container 100 having the second recessed portion 101 has been exemplified. In the modification 4, the description is made with respect to a container 100f that does not have a second recessed portion. FIG. 10 is a plan view illustrating a first side surface portion 110f according to the modification 4 of the embodiment. FIG. 10 is a view that corresponds to FIG. 6.

As illustrated in FIG. 10, a second recessed portion is not formed in a first side surface portion 110f of a container 100f, and the first side surface portion 110f has a shape having a corner portion at an end portion in the Z-axis plus direction and in the X-axis plus direction. The positive electrode terminal 310 and the outer gasket 400 are disposed on an upper surface of the corner portion.

### Modification 5

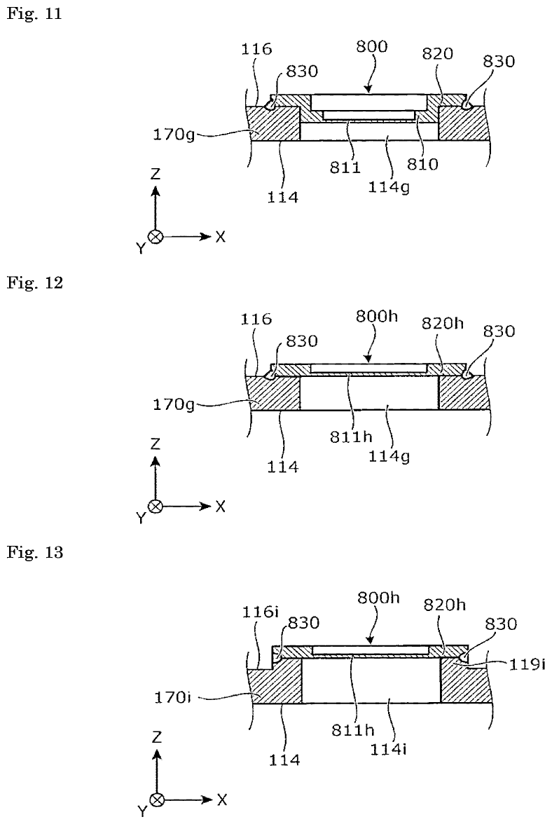

The modification 5 of the above-mentioned embodiment will be described. In the above-mentioned embodiment, the lid body 170 having the large-diameter portion 114b into which the outer edge portion 820 of the gas release valve 800 is inserted has been exemplified. In the modification 5, a case is described where the gas release valve 800 is mounted on a lid body 170g that does not have a large-diameter portion. FIG. 11 is a cross-sectional view illustrating a portion of the lid body 170g and the gas release valve 800 according to the modification 5 of the embodiment.

As illustrated in FIG. 11, although a hole 114g is formed in the lid body 170g, a large-diameter portion is not formed. When a fitting engagement portion 810 of the gas release valve 800 engages with the hole 114g by fitting engagement, a state is brought about where an outer edge portion 820 protrudes from a first inner surface 116 of the lid body 170g. Also in this case, a thin wall portion 811 of the gas release valve 800 is disposed between a first lower surface 114 and a first inner surface 116 of the lid body 170g.

### Modification 6

The modification 6 of the above-mentioned embodiment is described. In the above-mentioned embodiment, the gas release valve 800 having the fitting engagement portion 810 has been exemplified. In this modification 6, the description is made with respect to a gas release valve 800h that does not have a fitting engagement portion. FIG. 12 is a cross-sectional view illustrating a portion of a lid body 170g and a gas release valve 800 according to the modification 6 of the embodiment. FIG. 12 is a view that corresponds to FIG. 11.

As illustrated in FIG. 12, a gas release valve 800h is formed in a circular flat plate shape, and has a thin wall portion 811h at the center thereof. The gas release valve 800h is welded to a first inner surface 116 of a lid body 170g so as to close a hole 114g. An outer edge portion 820h of the gas release valve 800h is disposed outside a peripheral edge of the hole 114g over the entire circumference as viewed in the axial direction of the hole 114g.

### Modification 7

The modification 7 of the above-mentioned embodiment will be described. In the above embodiment, the lid body 170 where the first inner surface 116 is flat as a whole has been exemplified. In this modification 7, a lid body 170i where a peripheral edge of the hole 114i protrudes over the entire circumference on a first inner surface 116i is described. FIG. 13 is a cross-sectional view illustrating a portion of the lid body 170i and a gas release valve 800h according to the modification 7 of the embodiment. FIG. 13 is a view that corresponds to FIG. 12.

As illustrated in FIG. 13, a cylindrical portion 119i that protrudes over the entire circumference of the hole 114i is formed on the first inner surface 116i of the lid body 170i. The gas release valve 800h is mounted on a distal end portion of the cylindrical portion 119i so as to close the hole 114i. An outer edge portion 820h of the gas release valve 800h is disposed outside a peripheral edge of the hole 114i over the entire circumference as viewed in the axial direction of the hole 114i. A side surface of the outer edge portion 820h and the cylindrical portion 119i are continuously welded to each other over the entire circumference.

### Modification 8

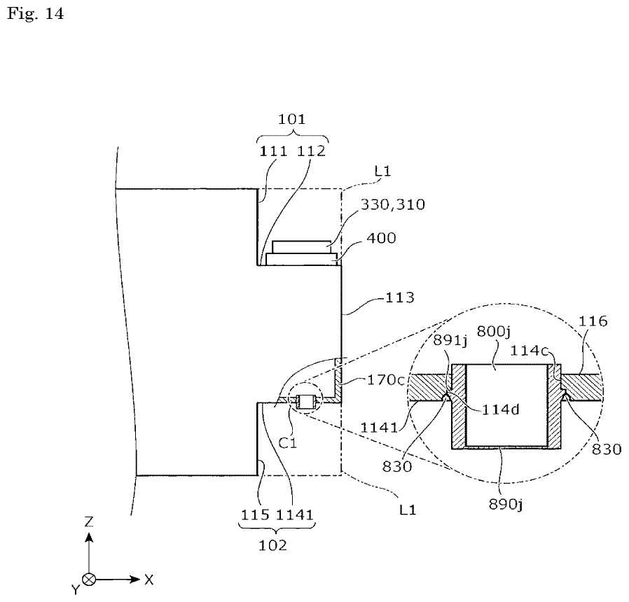

In the modification 1, the case has been exemplified where the disk-shaped gas release valve 800c is disposed on the first lower surface 1141 of the lid body 170c. The gas release valve 800c may be a cylindrical gas release valve. FIG. 14 is a plan view illustrating a gas release valve 800j according to modification 8 of the embodiment. FIG. 14 is a view that corresponds to FIG. 7.

The entirety of the gas release valve 800j is made of metal and is formed in a bottomed cylindrical shape. The gas release valve 800j is welded to a first lower surface 1141 in a state where the gas release valve 800j engages with a hole 114c formed in a lid body 170c by fitting engagement. To be more specific, the gas release valve 800j is formed into a bottomed cylindrical shape where an end portion in the Z-axis minus direction forms a bottom. The bottom of the gas release valve 800j is a valve element 890j having a wall thickness smaller than a wall thickness of the cylindrical portion. A protruding portion 891j that protrudes outward is formed on an outer peripheral surface of an intermediate portion of the gas release valve 800 in the axial direction. The protruding portion 891j is formed in a circular annular shape (in a flange shape) continuously over the entire circumference of the gas release valve 800j, engages with the large-diameter portion 114d by fitting engagement, and is welded to the large-diameter portion 114d. The protruding portion 891j may be bonded to the large-diameter portion 114d.

As described above, the gas release valve 800j is welded or bonded outside the lid body 170c and hence, it is possible to suppress the intrusion of dust caused by welding or bonding into the container. Accordingly, it is possible to enhance the reliability of the energy storage device 10.

### Other Modifications

Although the description has been made heretofore with respect to the energy storage device according to the embodiment of the present invention (including the modifications of the embodiment, the same understanding being adopted in the description made hereinafter), the present invention is not limited to the embodiment described above. The embodiment disclosed this time is illustrative in all aspects. The present invention includes all alterations which fall within the scope of claims or are considered equivalent to the present invention called for in claims.

For example, in the embodiment described above, the case is exemplified where only one electrode assembly 700 is accommodated in the container 100. However, a plurality of electrode assemblies may be accommodated in the container.

In the embodiment described above, the winding-type electrode assembly 700 has been exemplified. However, the shape of the electrode assembly is not limited to the winding type, and may be a stack type in which flat plate-shaped electrode plates are laminated, a shape in which the electrode plates and/or the separator are folded in a bellows shape, or the like. In all cases, it is sufficient that the stacking direction of the electrode assembly be set to the Y-axis direction. The electrode assembly may be a bipolar electrode assembly.

In the above-mentioned embodiment, the case is exemplified where the first recessed portion 102 is disposed at the same position in the first side surface portion 110 and the second side surface portion 120. However, the first recessed portion 102 may be disposed at different positions between the first side surface portion 110 and the second side surface portion 120. Alternatively, the first recessed portion 102 may be formed on only one of the first side surface portion 110 and the second side surface portion 120.

In the above-mentioned embodiment, the energy storage apparatus 1 that includes the plurality of spacers 20 has been exemplified. However, at least one spacer 20 may be provided, or the spacer 20 may not be provided.

In the above-mentioned embodiment, the energy storage apparatus 1 that includes the pair of gas discharge members 50 has been exemplified. However, at least one gas discharge member 50 may be provided, or the gas discharge member 50 may not be provided.

In the above-mentioned embodiment, the case has been exemplified where the cooling unit (refrigerant pipe 34) is disposed in the inside of the bottom wall 32 of the case body 30. However, the mounting position of the cooling unit is not limited provided that the cooling unit is disposed at a location that corresponds to the recessed portion that forms the gas flow path. For example, the cooling unit may be disposed in the inside of the side wall of the case body. Examples of the mounting position of the cooling unit other than such a position include the inside of the recessed portion that forms a gas flow path, the outside of the case body that faces the recessed portion with the bottom wall or the side wall interposed therebetween, and the like.

In the above embodiment, the cooling unit that is formed of the refrigerant pipe 34 is exemplified. However, the mode of the cooling unit is not limited provided that the cooling unit has a cooling function. Examples of the cooling unit include a cooling unit that uses a Peltier element and a cooling unit that supplies cold air.

In the above-mentioned embodiment, the case has been exemplified where the gas release valve 800 and the lid body 170 (container 100) that originally form separate bodies are joined to each other. However, the gas release valve and the container may be integrally formed with each other in advance. For example, in a case where a portion of the container is pressed and such a portion is used as a gas release valve, the gas release valve and the container can be integrally formed with each other.

The configurations that are formed by arbitrarily combining the respective constitutional elements that the embodiments and the modifications described above include also fall within the scope of the present invention.

### Industrial Applicability

The present invention is applicable to an energy storage device such as a lithium ion secondary battery or the like.

### DESCRIPTION OF REFERENCE SIGNS

1: energy storage apparatus
2: case
10: energy storage device
20: spacer
21: spacer recessed portion
30: case body
34: refrigerant pipe (cooling unit)
50: gas discharge member
100, 100f: container
101: second recessed portion
102, 102e: first recessed portion
110, 110c, 110d, 110e, 110f: first side surface portion
114, 1141: first lower surface
114a, 114c, 114g, 114i, 115e, 124a: hole
114b, 114d: large-diameter portion (recessed portion)
115, 115d: first lower side surface
116, 116i: first inner surface
120: second side surface portion
160: container body
170, 170c, 170d, 170g, 170i: lid body
300: terminal
600: current collector
700: electrode assembly
800, 800h, 800j: gas release valve
810: fitting engagement portion
811, 811h: thin wall portion
820, 820h: outer edge portion
830: welded portion
S1: first space
S2: second space
S3: third space
S4: fourth space

1. An energy storage device, comprising:
a container configured to accommodate an electrode assembly; and
a gas release valve positioned on the container and configured to release a gas from the container,
wherein the container has a recessed portion formed in a corner portion of a surface of the container or in a side portion of the surface of the container such that the recessed portion penetrates in a thickness direction of the container and that the gas release valve is positioned in the recessed portion of the container.

2. The energy storage device according to claim 1, wherein the container comprising metal and the gas release valve comprising metal separate from the container, and the container has a hole formed in the recessed portion such that the gas release valve is configured to close the hole and is joined to the container.

3. The energy storage device according to claim 2, wherein the gas release valve includes an outer edge portion positioned outside a peripheral edge of the hole in a penetrating direction of the hole and welded to the container, and the container has a recessed portion configured to allow insertion of the outer edge portion.

4. The energy storage device according to claim 1, further comprising:
a terminal,
wherein the container includes a second recessed portion formed in a second corner portion of the surface of the container such that the terminal is positioned in the second recessed portion of the container.

5. The energy storage device according to claim 4, wherein the second corner portion of the container is formed adjacent to the corner portion on the surface of the container.

6. An energy storage apparatus, comprising:
a plurality of energy storage devices; and
an outer case configured to accommodate the plurality of energy storage devices,
wherein each of the energy storage devices comprises the energy storage device of claim 1, and the plurality of energy storage devices is configured to be arrayed in the thickness direction of the container such that the recessed portion of each of the energy storage devices is configured to communicate with the recessed portion of another one of the energy storage devices in the thickness direction of the container.

7. The energy storage apparatus according to claim 6, further comprising:
a cooling unit positioned on the outer case such that the cooling unit is facing the recessed portion of the container.

8. The energy storage apparatus according to claim 6, further comprising:
a gas discharge member positioned in the recessed portion of the container over the plurality of energy storage devices in an array direction of the plurality of energy storage devices.

9. An energy storage apparatus comprising:
a plurality of energy storage devices; and
an outer case configured to accommodate the plurality of energy storage devices,
wherein each of the energy storage devices comprises the energy storage device of claim 4, and the plurality of energy storage devices is configured to be arrayed in the thickness direction of the container such that the second recessed portion of each of the energy storage devices is configured to communicate with another one of the energy storage devices in the thickness direction of the container.

10. The energy storage device according to claim 2, further comprising:
a terminal,
wherein the container includes a second recessed portion formed in a second corner portion of the surface of the container such that the terminal is positioned in the second recessed portion of the container.

11. The energy storage device according to claim 10, wherein the second corner portion of the container is formed adjacent to the corner portion on the surface of the container.

12. An energy storage apparatus, comprising:
a plurality of energy storage devices; and
an outer case configured to accommodate the plurality of energy storage devices,
wherein each of the energy storage devices comprises the energy storage device of claim 2, and the plurality of energy storage devices is configured to be arrayed in the thickness direction of the container such that the recessed portion of each of the energy storage devices is configured to communicate with the recessed portion of another one of the energy storage devices in the thickness direction of the container.

13. The energy storage apparatus according to claim 12, further comprising:
a cooling unit positioned on the outer case such that the cooling unit is facing the recessed portion of the container.

14. The energy storage apparatus according to claim 12, further comprising:
a gas discharge member positioned in the recessed portion of the container over the plurality of energy storage devices in an array direction of the plurality of energy storage devices.

15. An energy storage apparatus, comprising:
a plurality of energy storage devices; and
an outer case configured to accommodate the plurality of energy storage devices,
wherein each of the energy storage devices comprises the energy storage device of claim 10, and the plurality of energy storage devices is configured to be arrayed in the thickness direction of the container such that the second recessed portion of each of the energy storage devices is configured to communicate with another one of the energy storage devices in the thickness direction of the container.

16. The energy storage apparatus according to claim 7, further comprising:
a gas discharge member positioned in the recessed portion of the container over the plurality of energy storage devices in an array direction of the plurality of energy storage devices.

17. The energy storage apparatus according to claim 13, further comprising:
a gas discharge member positioned in the recessed portion of the container over the plurality of energy storage devices in an array direction of the plurality of energy storage devices.

18. An energy storage apparatus, comprising:
a plurality of energy storage devices; and
an outer case configured to accommodate the plurality of energy storage devices,
wherein each of the energy storage devices comprises the energy storage device of claim 3, and the plurality of energy storage devices is configured to be arrayed in the thickness direction of the container such that the recessed portion of each of the energy storage devices is configured to communicate with the recessed portion of another one of the energy storage devices in the thickness direction of the container.

19. The energy storage apparatus according to claim 18, further comprising:
a cooling unit positioned on the outer case such that the cooling unit is facing the recessed portion of the container.

20. The energy storage apparatus according to claim 18, further comprising:
a gas discharge member positioned in the recessed portion of the container over the plurality of energy storage devices in an array direction of the plurality of energy storage devices.
